(19) United States
(12) Patent Application Publication
(10) Pub. No.: US 2020/0348023 A1
(43) Pub. Date: Nov. 5, 2020

(54) COMBUSTOR LINER PANEL WITH MICRO-CIRCUIT CORE COOLING

(71) Applicant: United Technologies Corporation, Farmington, CT (US)

(72) Inventors: Corneil S. Paauwe, San Diego, CA (US); Eva Wong, Glastonbury, CT (US); San Quach, Southington, CT (US); Jeremy Styborski, East Hartford, CT (US); Caroline Karanian, West Hartford, CT (US); Lauryn M. Curtis, Manchester, CT (US); Steven D. Porter, Wethersfield, CT (US); Zhongtao Dai, West Hartford, CT (US)

(21) Appl. No.: 16/402,707

(22) Filed: May 3, 2019

(51) Int. Cl. F23R 3/00; F23R 3/04; F02C 7/18

(52) U.S. Cl. CPC F23R 3/002; F23R 3/005; F23R 3/04; F23R 2900/03043; F23R 2900/00017; F23R 2900/03044; F23R 2900/03045; F02C 7/18

(57) ABSTRACT

A gas turbine engine component assembly including: a first component having a first surface and a second surface opposite the first surface; a second component having a first surface and a second surface opposite the first surface of the second component; and a cooling circuit formed in the second component, the cooling circuit including an inlet at the second surface of the second component, an outlet at the first surface of the second component, an inward surface, and an outward surface, the inward surface and the outward surface being in a facing spaced relationship extending from the inlet to the outlet defining an airflow passageway therebetween, wherein the airflow passageway includes a parallel portion that is oriented about parallel to at least one of the first surface of the second component and the second surface of the second component.

### BACKGROUND

The subject matter disclosed herein generally relates to gas turbine engines and, more particularly, to a method and apparatus for mitigating heat in cooling surfaces of gas turbine engines using heat shield panels.

In one example, a combustor of a gas turbine engine may be configured to burn fuel in a combustion area. Such configurations may place substantial heat load on the structure of the combustor (e.g., heat shield panels, shells, etc.). Such heat loads may dictate that special consideration is given to structures, which may be configured as heat shields or panels, and to the cooling of such structures to protect these structures. Excess temperatures at these structures may lead to oxidation, cracking, and high thermal stresses of the heat shields panel.

### SUMMARY

According to an embodiment, a gas turbine engine component assembly is provided. The gas turbine component assembly including: a first component having a first surface and a second surface opposite the first surface; a second component having a first surface and a second surface opposite the first surface of the second component, the first surface of the first component and the second surface of the second component being in a facing spaced relationship defining a cavity therebetween; and a cooling circuit formed in the second component, the cooling circuit including an inlet at the second surface of the second component, an outlet at the first surface of the second component, an inward surface, and an outward surface, the inward surface and the outward surface being in a facing spaced relationship extending from the inlet to the outlet defining an airflow passageway therebetween, wherein the airflow passageway includes a parallel portion that is oriented about parallel to at least one of the first surface of the second component and the second surface of the second component.

In addition to one or more of the features described above, or as an alternative, further embodiments may include that the cooling circuit further includes: a tripping device extending into the airflow passageway away from at least one of the inward surface and the outward surface.

In addition to one or more of the features described above, or as an alternative, further embodiments may include that the cooling circuit further includes: a tripping device extending away from the inward surface into the airflow passageway.

In addition to one or more of the features described above, or as an alternative, further embodiments may include that the cooling circuit further includes: a tripping device extending away from the outward surface into the airflow passageway.

In addition to one or more of the features described above, or as an alternative, further embodiments may include that the cooling circuit further includes: a tripping device extending away from the inward surface to the outward surface through the airflow passageway.

In addition to one or more of the features described above, or as an alternative, further embodiments may include that the cooling circuit further includes: a tripping device extending away from the outward surface into the airflow passageway.

In addition to one or more of the features described above, or as an alternative, further embodiments may include that the outward surface may be oriented at a non-right angle relative to the first surface of the second component at the outlet.

According to another embodiment, a combustor for use in a gas turbine engine is provided. The combustor enclosing a combustion chamber having a combustion area. The combustor includes: a shell having an inner surface and an outer surface opposite the inner surface; a heat shield panel having a first surface and a second surface opposite the first surface of the heat shield panel, the inner surface of the shell and the second surface of the heat shield panel being in a facing spaced relationship defining a cavity therebetween; and a cooling circuit formed in the heat shield panel, the cooling circuit including an inlet at the second surface of the heat shield panel, an outlet at the first surface of the heat shield panel, an inward surface, and an outward surface, the inward surface and the outward surface being in a facing spaced relationship extending from the inlet to the outlet defining an airflow passageway therebetween, wherein the airflow passageway includes a parallel portion that is oriented about parallel to at least one of the first surface of the heat shield panel and the second surface of the heat shield panel.

In addition to one or more of the features described above, or as an alternative, further embodiments may include that the cooling circuit further includes: a tripping device extending into the airflow passageway away from at least one of the inward surface and the outward surface.

In addition to one or more of the features described above, or as an alternative, further embodiments may include that the cooling circuit further includes: a tripping device extending away from the inward surface into the airflow passageway.

In addition to one or more of the features described above, or as an alternative, further embodiments may include that the cooling circuit further includes: a tripping device extending away from the outward surface into the airflow passageway.

In addition to one or more of the features described above, or as an alternative, further embodiments may include that the cooling circuit further includes: a tripping device extending away from the inward surface to the outward surface through the airflow passageway.

In addition to one or more of the features described above, or as an alternative, further embodiments may include that the cooling circuit further includes: a tripping device extending away from the outward surface into the airflow passageway.

In addition to one or more of the features described above, or as an alternative, further embodiments may include that the outward surface may be oriented at a non-right angle relative to the first surface of the heat shield panel at the outlet.

According to another embodiment, a heat shield panel for use in a gas turbine engine is provided. The heat shield panel including: a first surface; a second surface opposite the first surface of the heat shield panel; and a cooling circuit formed in the heat shield panel, the cooling circuit including an inlet at the second surface of the heat shield panel, an outlet at the first surface of the heat shield panel, an inward surface, and an outward surface, the inward surface and the outward surface being in a facing spaced relationship extending from the inlet to the outlet defining an airflow passageway therebetween, wherein the airflow passageway includes a parallel portion that is oriented about parallel to at least one of the first surface of the heat shield panel and the second surface of the heat shield panel.

In addition to one or more of the features described above, or as an alternative, further embodiments may include that the cooling circuit further includes: a tripping device extending into the airflow passageway away from at least one of the inward surface and the outward surface.

In addition to one or more of the features described above, or as an alternative, further embodiments may include that the cooling circuit further includes: a tripping device extending away from the inward surface into the airflow passageway.

In addition to one or more of the features described above, or as an alternative, further embodiments may include that the cooling circuit further includes: a tripping device extending away from the outward surface into the airflow passageway.

In addition to one or more of the features described above, or as an alternative, further embodiments may include that the cooling circuit further includes: a tripping device extending away from the inward surface to the outward surface through the airflow passageway.

In addition to one or more of the features described above, or as an alternative, further embodiments may include that the outward surface may be oriented at a non-right angle relative to the first surface of the heat shield panel at the outlet.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

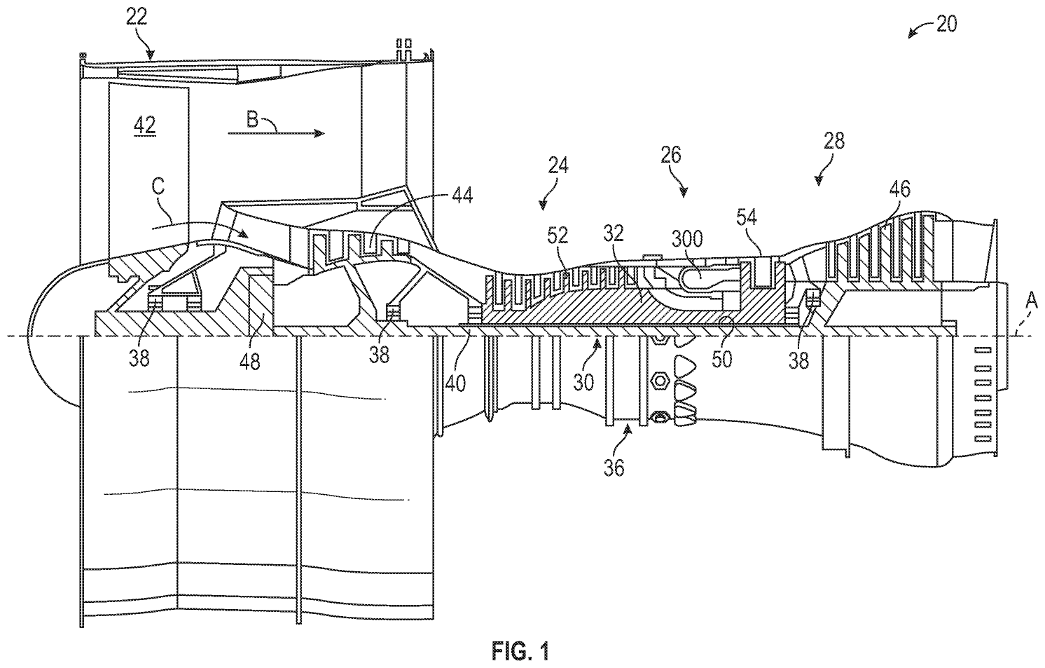

FIG. 1 is a partial cross-sectional illustration of a gas turbine engine;

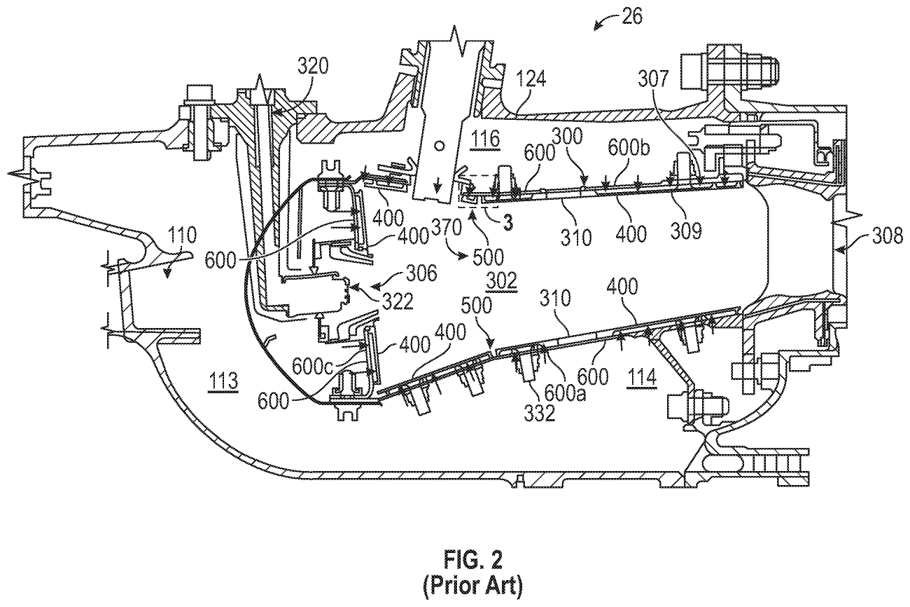

FIG. 2 is a cross-sectional illustration of a combustor;

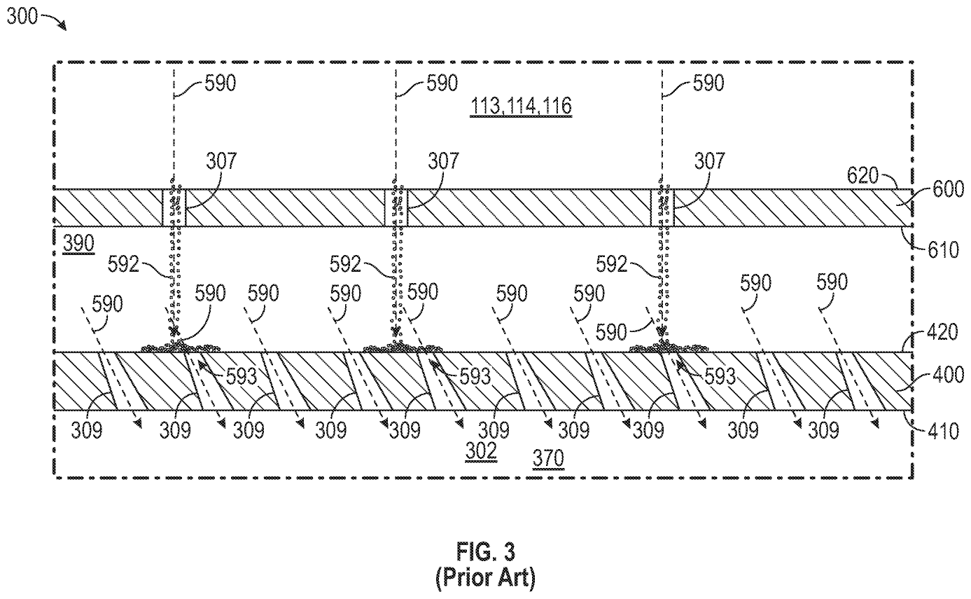

FIG. 3 is an enlarged view of a shell and a heat shield panel for use in a combustor of a gas turbine engine; and

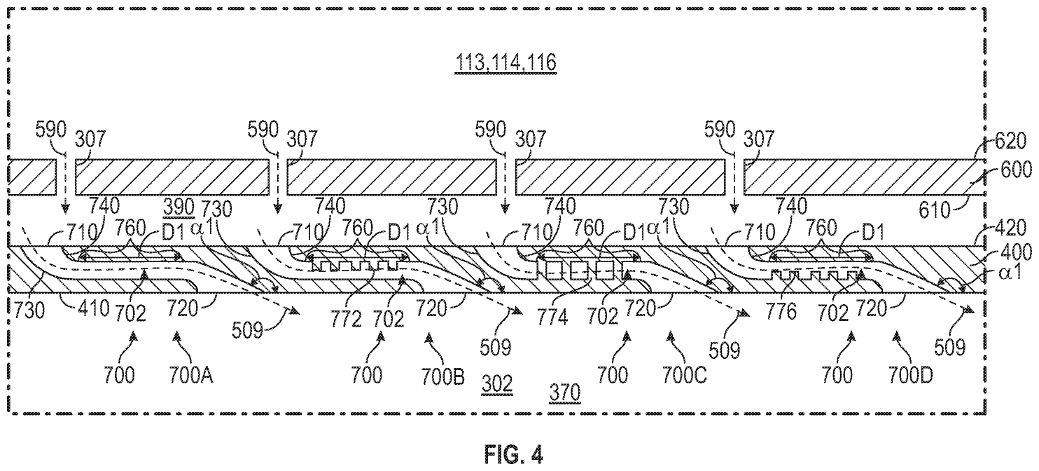

FIG. 4 is an enlarged view of a shell and a heat shield panel of a combustor for use in a combustor of a gas turbine engine, the heat shield panel including a cooling circuit, in accordance with an embodiment of the present disclosure.

The detailed description explains embodiments of the present disclosure, together with advantages and features, by way of example with reference to the drawings.

### DETAILED DESCRIPTION

A detailed description of one or more embodiments of the disclosed apparatus and method are presented herein by way of exemplification and not limitation with reference to the Figures.

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 300 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 300, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

Referring now to FIG. 2, with continued reference to FIG. 1, the combustor section 26 of the gas turbine engine 20 is shown. The combustor 300 of FIG. 2 is an impingement film float wall combustor. It is understood that while an impingement film float wall combustor is utilized for exemplary illustration, the embodiments disclosed herein may be applicable to other types of combustors for gas turbine engines including but not limited to double pass liner combustors, float wall combustors, and combustors with single wall liners.

As illustrated, a combustor 300 defines a combustion chamber 302. The combustion chamber 302 includes a combustion area 370 within the combustion chamber 302. The combustor 300 includes an inlet 306 and an outlet 308 through which air may pass. The air may be supplied to the combustor 300 by a pre-diffuser 110. Air may also enter the combustion chamber 302 through other holes in the combustor 300 including but not limited to quench holes 310, as seen in FIG. 2.

Compressor air is supplied from the compressor section 24 into a pre-diffuser 110, which then directs the airflow toward the combustor 300. The combustor 300 and the pre-diffuser 110 are separated by a dump region 113 from which the flow separates into an inner shroud 114 and an outer shroud 116. As air enters the dump region 113, a portion of the air may flow into the combustor inlet 306, a portion may flow into the inner shroud 114, and a portion may flow into the outer shroud 116.

The air from the inner shroud 114 and the outer shroud 116 may then enter the combustion chamber 302 by means of one or more primary apertures 307 in the shell 600 and one or more secondary apertures 309, as shown in FIGS. 2 and 3. The primary apertures 307 and secondary apertures 309 may include nozzles, holes, etc. The air may then exit the combustion chamber 302 through the combustor outlet 308. At the same time, fuel may be injected into the combustion chamber 302 through the primary and/or secondary orifices of a fuel injector 320 and a pilot nozzle 322, which may be atomized and mixed with air, and then ignited and burned within the combustion chamber 302. The combustor 300 of the engine combustion section 26 may be housed within diffuser cases 124 which may define the inner shroud 114 and the outer shroud 116.

The combustor 300, as shown in FIG. 2, includes multiple heat shield panels 400 that are attached to one or more shells 600 (See FIG. 3). The heat shield panels 400 may be arranged parallel to the shell 600. The shell 600 includes a radially inward shell 600a and a radially outward shell 600b in a facing spaced relationship defining the combustion chamber 302 therebetween. The shell 600 also includes a forward shell 600c extending between the radially inward shell 600a and the radially outward shell 600b. The forward shell 600c further bounds the combustion chamber 302 on a forward end. The radially inward shell 600a and the radially outward shell 600b extend circumferentially around the longitudinal engine axis A. The radial inward shell 600a is located radially inward from the radially outward shell 600b.

The heat shield panels 400 can be removably mounted to the shell 600 by one or more attachment mechanisms 332. In some embodiments, the attachment mechanism 332 may be integrally formed with a respective heat shield panel 400, although other configurations are possible. In some embodiments, the attachment mechanism 332 may be a threaded mounting stud or other structure that may extend from the respective heat shield panel 400 through the interior surface to a receiving portion or aperture of the shell 600 such that the heat shield panel 400 may be attached to the shell 600 and held in place. The heat shield panels 400 partially enclose a combustion area 370 within the combustion chamber 302 of the combustor 300.

Referring now to FIG. 3, with continued reference to FIGS. 1 and 2, a heat shield panel 400 and shell 600 of the combustor 300 (see FIG. 2) conventionally used within the gas turbine engine 20 (see FIG. 1). Combustors 300 of gas turbine engines 20, as well as other components, experience elevated heat levels during operation. Impingement and convective cooling of heat shield panels 400 of the combustor 300 may be used to help cool the combustor 300. Convective cooling may be achieved by air that is channeled between the heat shield panels 400 and a shell 600 of the combustor 300. Impingement cooling may be a process of directing relatively cool air from a location exterior to the combustor 300 toward a back or underside of the heat shield panels 400.

Thus, heat shield panels 400 are utilized to face the hot products of combustion within a combustion chamber 302 and protect the overall shell 600 of the combustor 300. The heat shield panels 400 may be supplied with cooling air including dilution passages which deliver a high volume of cooling air into a hot flow path. The cooling air may be air from the compressor of the gas turbine engine 20. The cooling air may impinge upon a back side (i.e., second surface 420) of the heat shield panel 400 that faces the shell 600 inside the combustor 300. The cooling air may contain particulates, which may build up on the heat shield panels 400 overtime, thus reducing the cooling ability of the cooling air. Embodiments disclosed herein seek to address particulate adherence to the heat shield panels 400 in order to maintain the cooling ability of the cooling air.

The heat shield panel 400 and the shell 600 are in a facing spaced relationship. The heat shield panel 400 includes a first surface 410 oriented towards the combustion area 370 of the combustion chamber 302 and a second surface 420 opposite the first surface 410 oriented towards the shell 600. The shell 600 has an inner surface 610 and an outer surface 620 opposite the inner surface 610. The inner surface 610 is oriented toward the heat shield panel 400. The outer surface 620 is oriented outward from the combustor 300 proximate the inner shroud 114 and the outer shroud 116.

The shell 600 includes a plurality of primary apertures 307 configured to allow airflow 590 from the inner shroud 114 and the outer shroud 116 to enter a cavity 390 located between the shell 600 and the heat shield panel 400. Each of the primary apertures 307 extend from the outer surface 620 to the inner surface 610 through the shell 600.

Each of the primary apertures 307 fluidly connects the cavity 390 to at least one of the inner shroud 114 and the outer shroud 116. The heat shield panel 400 may include one or more secondary apertures 309 configured to allow airflow 590 from the cavity 390 to the combustion area 370 of the combustion chamber 302.

Each of the secondary apertures 309 extend from the second surface 420 to the first surface 410 through the heat shield panel 400. Airflow 590 flowing into the cavity 390 impinges on the second surface 420 of the heat shield panel 400 and absorbs heat from the heat shield panel 400.

As seen in FIG. 3, particulate 592 may accompany the airflow 590 flowing into the cavity 390. Particulate 592 may include but is not limited to dirt, smoke, soot, volcanic ash, or similar airborne particulate known to one of skill in the art. As the airflow 590 and particulate 592 impinge upon the second surface 420 of the heat shield panel 400, the particulate 592 may begin to collect on the second surface 420, as seen in FIG. 3. Particulate 592 collecting upon the second surface 420 of the heat shield panel 400 reduces the cooling efficiency of airflow 590 impinging upon the second surface 420 and thus may increase local temperatures of the heat shield panel 400 and the shell 600. Particulate 592 collection upon the second surface 420 of the heat shield panel 400 may potentially create a blockage 593 to the secondary apertures 309 in the heat shield panels 400, thus reducing airflow 590 into the combustion area 370 of the combustion chamber 302. The blockage 593 may be a partial blockage or a full blockage.

Referring now to FIG. 4, with continued reference to FIGS. 1-3, a heat shield panel 400 and shell 600 of the combustor 300 (see FIG. 2) for the gas turbine engine 20 (see FIG. 1). The heat shield panel 400 and the shell 600 are in a facing spaced relationship. The heat shield panel 400 includes a first surface 410 oriented towards the combustion area 370 of the combustion chamber 302 and a second surface 420 opposite the first surface 410 oriented towards the shell 600. The shell 600 has an inner surface 610 and an outer surface 620 opposite the inner surface 610. The inner surface 610 is oriented toward the heat shield panel 400. The outer surface 620 is oriented outward from the combustor 300 proximate the inner shroud 114 and the outer shroud 116.

The shell 600 includes a plurality of primary apertures 307 configured to allow airflow 590 from the inner shroud 114 and the outer shroud 116 to enter a cavity 390 located between the shell 600 and the heat shield panel 400. Each of the primary apertures 307 extend from the outer surface 620 to the inner surface 610 through the shell 600. Each of the primary apertures 307 fluidly connects the cavity 390 to at least one of the inner shroud 114 and the outer shroud 116.

The heat shield panel 400 may include one or more cooling circuits 700 configured to allow airflow 590 from the cavity 390 to the combustion area 370 of the combustion chamber 302. The cooling circuit 700 of the heat shield panel 400 may be formed using various methods include but not limited to additive manufacturing, casting, machining, welding, forming, or investment casting with expendable ceramic cores used to create cooling circuit channels. Each of the cooling circuits 700 includes an airflow passageway 702 that extends from the second surface 420 to the first surface 410 through the heat shield panel 400. The cooling circuit 700 may include an inlet 710 at the second surface 420 and an outlet 720 at the first surface 410. The inlet 710 is fluidly connected to the outlet 720 through the airflow passageway 702. The inlet 710 fluidly connects the cooling circuit 700 to the cavity 390 and the outlet fluidly connects the cooling circuit 700 to the combustion area 370 of the combustion chamber 302.

An inward surface 730 and an outward surface 740 may define the airflow passageway 702 therebetween, as illustrated in FIG. 4. The inward surface 730 extends from the second surface 420 of the heat shield panel 400 to the first surface 410 of the heat shield panel 400. The inward surface 730 extends from the inlet 710 to the outlet 720 through the heat shield panel 400. The outward surface 740 extends from the second surface 420 of the heat shield panel 400 to the first surface 410 of the heat shield panel 400. The outward surface 740 extends from the inlet 710 to the outlet 720 through the heat shield panel 400. The inward surface 730 and the outward surface 740 may be in a facing spaced relationship extending from the inlet 710 to the outlet 720 defining the airflow passageway 702 therebetween, as shown in FIG. 4.

At the outlet 720, the outward surface 740 may be oriented at a selected angle α1 relative to the first surface 410 of the heat shield panel 400. In an embodiment, the selected angle α1 is a non-right angle. (i.e., any angle that is not a right angle, perpendicular angle, or 90° angle). A non-right angle may include an acute angle relative to the first surface 410 or an obtuse angle relative to the first surface 410. Advantageously, the selected angle α1 allows the cooling circuit 700 to direct airflow 590 of the outlet 720 and about parallel to the first surface 410 of the heat shield panel 400, thus creating a cooling film of airflow 590 on the first surface 410 of the heat shield panel 400. This cooling film help protect the first surface 410 of the heat shield panel 400 from the excessive heat in the combustion area 370 by cooling the first surface 410 of the heat shield panel.

The airflow passageway 702 may include a parallel portion 760 that may be is oriented about parallel to at least one of the first surface 410 of the heat shield panel 400 and the second surface 420 of the heat shield panel 400. Within the parallel portion 760 the inward surface 730 may be oriented about parallel with the first surface 410 and/or the outward surface 740 may be oriented about parallel with the second surface 420. The parallel portion 760 may extend a first length D1 through the heat shield panel 400. Advantageously, by diverting the airflow 590 through the parallel portion 760 for the first length D1, the surface area for convective heat transfer between the heat shield panel 400 and the airflow 590 within the cooling circuit 700 is greater than the secondary apertures shown in FIG. 3. Also advantageously, the airflow passageway 702 creates an additional surface for convective heat transfer between the heat shield panel 400 and the airflow 590 if particulate 592 has built up on the second surface 420, which impedes heat transfer between the airflow 590 and the second surface 420 of the heat shield panel 400, see FIG. 3. Also advantageously, by diverting the airflow 590 through the parallel portion 760 for the first length D1, the traverse flow of airflow 590 through the cooling circuit 700 discourages collection of particulate 592 on the second surface 420 of the heat shield panel 400 more than the substantially perpendicular flow shown in FIG. 3.

The cooling circuit 700 may also include tripping devices 772, 774, 776 that may be incorporated into airflow passageway 702. The tripping devices 772, 774, 776 may be rounded pins, rough patches of surface area or any obstacle protruding away from the inward surface 730 or the outward surface 740. As shown at 700B in FIG. 4, the cooling circuit 700 may include one or more tripping devices 772 extending away from the outward surface 740 into the airflow passageway 702 of cooling circuit 700. As shown at 700D in FIG. 4, the cooling circuit 700 may include one or more tripping devices 776 extending away from the inward surface 730 into the airflow passageway 702 of cooling circuit 700. As shown at 700C in FIG. 4, the cooling circuit 700 may include one or more tripping devices 774 extending away from the inward surface 730 to the outward surface 740 through the airflow passageway 702 of cooling circuit 700. As shown at 700A in FIG. 4, the cooling circuit 700 may include no tripping devices 772, 774, 776.

Advantageously, the tripping devices 772, 774, 776 increase the surface area of the cooling circuit for convective heat transfer between the heat shield panel 400 and the airflow 590 within the cooling circuit 700. Also advantageously, the tripping devices 772, 774, 776 also trips the airflow 590 and create turbulence in the airflow 590 within the cooling circuit 700 to firm aid in the convective heat transfer between the heat shield panel 400 and the airflow 590 within the cooling circuit 700.

It is understood that a combustor of a gas turbine engine is used for illustrative purposes and the embodiments disclosed herein may be applicable to additional components of other than a combustor of a gas turbine engine, such as, for example, a first component and a second component defining an impingement channel therebetween. The first component may have cooling holes similar to the primary orifices. The cooling holes may direct air through the cooling channel to impinge upon the second component.

Technical effects of embodiments of the present disclosure include incorporating a cooling circuit within a heat shield panel of combustor to increase convective heat transfer of cooling airflow through the heat shield panel.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A gas turbine engine component assembly, comprising:
a first component having a first surface and a second surface opposite the first surface;
a second component having a first surface and a second surface opposite the first surface of the second component, the first surface of the first component and the second surface of the second component being in a facing spaced relationship defining a cavity therebetween; and
a cooling circuit formed in the second component, the cooling circuit comprising an inlet at the second surface of the second component, an outlet at the first surface of the second component, an inward surface, and an outward surface, the inward surface and the outward surface being in a facing spaced relationship extending from the inlet to the outlet defining an airflow passageway therebetween,
wherein the airflow passageway includes a parallel portion that is oriented about parallel to at least one of the first surface of the second component and the second surface of the second component.

2. The gas turbine engine component assembly of claim 1, wherein the cooling circuit further comprises:
a tripping device extending into the airflow passageway away from at least one of the inward surface and the outward surface.

3. The gas turbine engine component assembly of claim 1, wherein the cooling circuit further comprises:
a tripping device extending away from the inward surface into the airflow passageway.

4. The gas turbine engine component assembly of claim 1, wherein the cooling circuit further comprises:
a tripping device extending away from the outward surface into the airflow passageway.

5. The gas turbine engine component assembly of claim 1, wherein the cooling circuit further comprises:
a tripping device extending away from the inward surface to the outward surface through the airflow passageway.

6. The gas turbine engine component assembly of claim 3, wherein the cooling circuit further comprises:
a tripping device extending away from the outward surface into the airflow passageway.

7. The gas turbine engine component assembly of claim 1, wherein the outward surface may be oriented at a non-right angle relative to the first surface of the second component at the outlet.

8. A combustor for use in a gas turbine engine, the combustor enclosing a combustion chamber having a combustion area, wherein the combustor comprises:
a shell having an inner surface and an outer surface opposite the inner surface;
a heat shield panel having a first surface and a second surface opposite the first surface of the heat shield panel, the inner surface of the shell and the second surface of the heat shield panel being in a facing spaced relationship defining a cavity therebetween; and
a cooling circuit formed in the heat shield panel, the cooling circuit comprising an inlet at the second surface of the heat shield panel, an outlet at the first surface of the heat shield panel, an inward surface, and an outward surface, the inward surface and the outward surface being in a facing spaced relationship extending from the inlet to the outlet defining an airflow passageway therebetween,
wherein the airflow passageway includes a parallel portion that is oriented about parallel to at least one of the first surface of the heat shield panel and the second surface of the heat shield panel.

9. The combustor of claim 8, wherein the cooling circuit further comprises:
a tripping device extending into the airflow passageway away from at least one of the inward surface and the outward surface.

10. The combustor of claim 8, wherein the cooling circuit further comprises:
a tripping device extending away from the inward surface into the airflow passageway.

11. The combustor of claim 8, wherein the cooling circuit further comprises:
a tripping device extending away from the outward surface into the airflow passageway.

12. The combustor of claim 8, wherein the cooling circuit further comprises:
a tripping device extending away from the inward surface to the outward surface through the airflow passageway.

13. The combustor of claim 10, wherein the cooling circuit further comprises:
a tripping device extending away from the outward surface into the airflow passageway.

14. The combustor of claim 8, wherein the outward surface may be oriented at a non-right angle relative to the first surface of the heat shield panel at the outlet.

15. A heat shield panel for use in a gas turbine engine, the heat shield panel comprising:
a first surface;
a second surface opposite the first surface of the heat shield panel; and
a cooling circuit formed in the heat shield panel, the cooling circuit comprising an inlet at the second surface of the heat shield panel, an outlet at the first surface of the heat shield panel, an inward surface, and an outward surface, the inward surface and the outward surface being in a facing spaced relationship extending from the inlet to the outlet defining an airflow passageway therebetween,
wherein the airflow passageway includes a parallel portion that is oriented about parallel to at least one of the first surface of the heat shield panel and the second surface of the heat shield panel.

16. The heat shield panel of claim 15, wherein the cooling circuit further comprises:
a tripping device extending into the airflow passageway away from at least one of the inward surface and the outward surface.

17. The heat shield panel of claim 15, wherein the cooling circuit further comprises:
a tripping device extending away from the inward surface into the airflow passageway.

18. The heat shield panel of claim 15, wherein the cooling circuit further comprises:
a tripping device extending away from the outward surface into the airflow passageway.

19. The heat shield panel of claim 15, wherein the cooling circuit further comprises:
a tripping device extending away from the inward surface to the outward surface through the airflow passageway.

20. The heat shield panel of claim 15, wherein the outward surface may be oriented at a non-right angle relative to the first surface of the heat shield panel at the outlet.
